(19) United States
(12) Patent Application Publication
(10) Pub. No.: US 2020/0327516 A1
(43) Pub. Date: Oct. 15, 2020

(54) SYSTEMS AND METHODS FOR PROVIDING COST-SHARING TRANSPORTATION SERVICES

(71) Applicant: BEIJING DIDI INFINITY TECHNOLOGY AND DEVELOPMENT CO., LTD., Beijing (CN)

(72) Inventors: Aijing BAI, Beijing (CN); Yang LI, Beijing (CN); Bin PAN, Mountain View, CA (US)

(73) Assignee: BEIJING DIDI INFINITY TECHNOLOGY AND DEVELOPMENT CO., LTD., Beijing (CN)

(21) Appl. No.: 16/892,481

(22) Filed: Jun. 4, 2020

Related U.S. Application Data
(63) Continuation of application No. PCT/CN2018/116068, filed on Nov. 17, 2018.

(30) Foreign Application Priority Data
Dec. 4, 2017 (CN) PCT/CN2017/114376
May 18, 2018 (CN) PCT/CN2018/087442

(51) Int. Cl. G06Q 20/14; B60W 60/00; G06Q 20/22; G01C 21/34

(52) U.S. Cl. CPC G06Q 20/145; G01C 21/3453; G06Q 20/223; B60W 60/00253

(57) ABSTRACT

Systems and methods for providing a cost-sharing transportation service are provided. An exemplary system may include a memory and at least one processor coupled to the memory. The at least one processor, when executing instructions stored on the memory, perform operations. The operations may include providing a cost-sharing option to a first user. The operations may also include receiving input from the first user indicating a selection of the cost-sharing option. The operations may also include providing information of a pick-up area to the first user based on an origin location. The operations may also include searching for a second user associated with the cost-sharing option. The operations may also include determining a pick-up location associated with the cost-sharing option. The operations may also include providing, to the first user, information of the pick-up location.

### RELATED APPLICATIONS

The present application is a Continuation of International Application No. PCT/CN2018/116068, filed on Nov. 17, 2018, which claims the benefits of priority to PCT/CN2017/114376, file Dec. 4, 2017 and PCT/CN2018/087442, filed May 18, 2018. The entire contents of the above-identified applications are expressly incorporated herein by reference.

### TECHNICAL FIELD

The present disclosure relates to providing transportation services, and more particularly, to systems and methods for providing cost-sharing transportation services using an online platform.

### BACKGROUND

An online hailing platform (e.g., DiDi™ online) can receive a ride-hailing service request from a passenger and then route the service request to at least one transportation service provider (e.g., a taxi driver, a private car owner, or the like). The service request can be answered by a service provider or assigned to a service provider if no one picks up the service request within a predetermined time period.

When multiple passengers go to similar destinations or share similar routes, they can be pooled together to share the same service vehicle, as well as the cost. This cost-sharing arrangement is also referred to as carpooling. Current online hailing platforms providing the cost-sharing option do not provide sufficient information about the pick-up location to a passenger prior to matching the passenger with a driver and/or a co-rider. After the pick-up location is revealed to the passenger, a co-rider or driver may have already been found. At this time, if the passenger chooses to cancel the transportation request due to a long walking distance to the pick-up location, the cancellation would adversely affect the already matched driver or co-rider. On the other hand, if the exact pick-up location is revealed to the passenger too early, it may allow for potential exploitation or raise safety concerns. As a result, current systems face the dilemma between early and late revelations of the pick-up location information to the passenger.

Embodiments of the present disclosure provide methods and systems that address the aforementioned shortcomings.

### SUMMARY

Embodiments of the disclosure provide a system for providing a cost-sharing transportation service. The system may include a memory storing computer-readable instructions and at least one processor coupled to the memory. The instructions stored on the memory, when executed by the at least one processor, may cause the processor to perform operations. The operations may include providing a cost-sharing option to a first user. The operations may also include receiving input from the first user indicating a selection of the cost-sharing option. The operations may also include providing information of a pick-up area to the first user based on an origin location. The operations may also include searching for a second user associated with the cost-sharing option. The operations may also include determining a pick-up location associated with the cost-sharing option. The operations may also include providing, to the first user, information of the pick-up location.

Embodiments of the disclosure further disclose a computer-implemented method for providing a cost-sharing transportation service. The method may include providing a cost-sharing option to a first user. The method may also include receiving input from the first user indicating a selection of the cost-sharing option. The method may also include providing information of a pick-up area to the first user based on an origin location. The method may also include searching for a second user associated with the cost-sharing option. The method may also include determining a pick-up location associated with the cost-sharing option. The method may also include providing, to the first user, information of the pick-up location.

Embodiments of the disclosure further disclose a non-transitory computer-readable medium. The non-transitory computer-readable medium may store a set of instructions, when executed by at least one processor of an electronic device, cause the electronic device to perform a method for providing a cost-sharing transportation service. The method may include providing a cost-sharing option to a first user. The method may also include receiving input from the first user indicating a selection of the cost-sharing option. The method may also include providing information of a pick-up area to the first user based on an origin location. The method may also include searching for a second user associated with the cost-sharing option. The method may also include determining a pick-up location associated with the cost-sharing option. The method may also include providing, to the first user, information of the pick-up location.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary system for providing a cost-sharing transportation service, according to embodiments of the disclosure.

FIG. 2 illustrates a block diagram of an exemplary terminal device configured to provide a cost-sharing transportation service, according to embodiments of the disclosure.

FIG. 3 illustrates a block diagram of an exemplary server configured to provide a cost-sharing transportation service, according to embodiments of the disclosure.

FIGS. 4A-4B illustrate a flowchart of an exemplary method for provide a cost-sharing transportation service, according to embodiments of the disclosure.

FIGS. 5A-5E are exemplary interfaces showing various stages of requesting a cost-sharing transportation service, according to embodiments of the disclosure.

FIG. 6 is an exemplary interface showing co-rider matching during a cost-sharing transportation service, according to embodiments of the disclosure.

FIG. 7 is an exemplary interface showing seat selection during a cost-sharing transportation service, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the disclosure provide systems and methods for providing cost-sharing transportation services. In some embodiments, a cost-sharing transportation service may reward sharing of a transportation vehicle by splitting the cost among co-riders. In some embodiments, the cost-sharing transportation service may reward a willingness to share a transportation vehicle, regardless of whether the transportation vehicle is actually shared by multiple users. In this case, cost-sharing may be reflected in the form of a discount to the regular transportation service fare, a flat rate, or other forms of reduced fare. In some embodiments, the cost-sharing service may be provided as an option to a user in addition to regular transportation services. As used herein, the cost-sharing service may also be referred to as a cost-sharing option, a cost-saving service/option, a carpooling service/option, a carpool service/option, or similar terms.

Embodiments of the disclosure provide a mechanism to provide a user who takes advantage of the cost-sharing service with information of a pick-up location. Unlike current systems, where a passenger who wants to take advantage of the cost-sharing service is left with no choice but to accept a system-assigned pick-up location or cancel the already matched-up ride request, embodiments of the present disclosure allow a user to assess the walking distance to the pick-up location by depicting a pick-up area before the cost-sharing service request is broadcast to potential drivers and co-riders. The pick-up area defines the boundary of the pick-up location, which informs the user an upper limit to the walking distance before the user's cost-sharing transportation request is sent for matching. If the user decides not to proceed, he/she may choose other forms of transportation services without having to cancel an ongoing order. In other words, instead of revealing the exact pick-up location, or, to another extreme, concealing the pick-up location till a match-up is found, embodiments of the present disclosure balance the interests of both the passenger and the service platform provider.

In addition, embodiments of the present disclosure may provide suggested/recommended pick-up location(s) within the pick-up area. The user may choose the pick-up location from multiple recommended pick-up locations. The recommended pick-up locations may be determined based on historical information to balance the interests of the passenger, driver, and/or co-rider(s).

In some embodiments, exemplary systems and methods may be implemented as part of an online ride-hailing service (also referred to as an online ride-sharing service), where a driver provides transportation service to one or more passengers using a service vehicle. In such a context, the driver and one or more passengers may communicate using terminal devices, such as mobile phones, wearable devices, PDAs, etc. The online ride-hailing service may be provided via a service platform that facilitates communications among the terminal devices and between the terminal devices and a server.

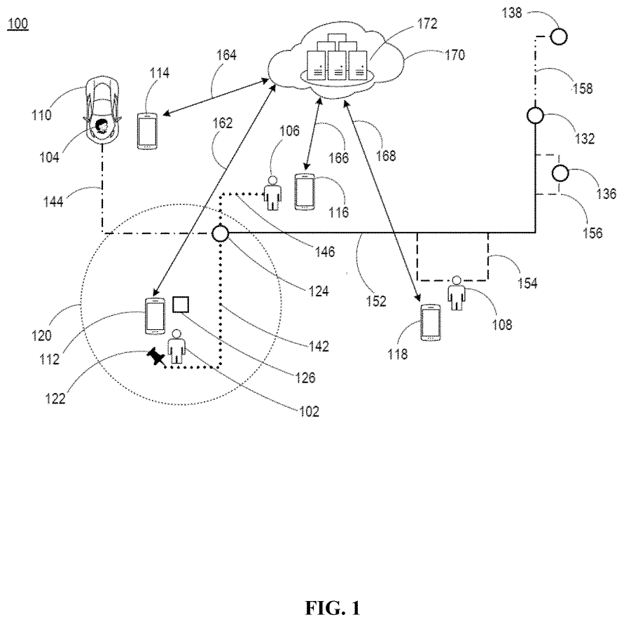

FIG. 1 illustrates an exemplary system 100 for providing a cost-sharing transportation service. As shown in FIG. 1, a user 102 may use a terminal device 112 to request a transportation service. For example, terminal device 112 may have a service application installed thereon to display a user interface that allows user 102 to input information pertinent to the transportation service. The request may include information of an origin location 126 and a destination location 132. As used herein, origin location 126 may or may not be the same as user 102's current physical location 122. Further, origin location 126 may or may not be the same as pick-up location 124. In some embodiments, user 102 may be provided with a cost-sharing option before inputting the origin/destination location information. In some embodiments, the origin location may indicate the location where user 102 uses as the “from” location for a transportation service. For example, to make a transportation service request, user 102 may input the address of the origin location through the service application installed on terminal device 112. User 102 may also manipulate a map shown on a user interface displayed by terminal device 112 to indicate the origin location 126 on the map. In some embodiments, origin location 126 may be depicted by an indicator, such as a pin, on the map. User 102 may “drag” the pin or the map to change the position of the pin on the map.

In some embodiments, the transportation service request may be sent from terminal device 112 to a server 172 through a communication link 162. Server 172 may be provided in a cloud computing environment 170 (referred herein as “cloud 170” for simplicity). Communication link 162 may include any suitable communication channels, such as a wireless communication channel via a suitable network. After server 172 receives the request, server 172 may determine whether a cost-sharing option is available based on the origin and/or destination location of user 102. In some embodiments, the cost-sharing transportation service may be available in specific geographical areas, such as cities, counties, towns, metropolitan areas, etc. In such embodiments, server 172 may determine if the origin and/or destination falls within a predetermined geographical area that offers the cost-sharing service. After determining that the cost-sharing service is available, server 172 may provide the cost-sharing option to user 102. In some embodiment, the cost-sharing option may be provided as default transportation service option to user 102 in an area where the cost-sharing service is available.

The cost-sharing option may be accompanied by a price. The price may include a discount compared to the regular price to reflect the cost-sharing feature. In some embodiments, the price may be fixed, regardless of whether actual sharing of service vehicle occurs.

Terminal device 112 may receive input from user 102 indicating a selection of the cost-sharing option. For example, user 102 may select the cost-sharing option via the user interface displayed on a screen of terminal device 112. In some embodiments, user 102 may be provided with a user interface requesting confirmation of the number of seats needed. For example, a default number of one seat and a maximum number of two seats may be implemented.

After user 102 selects the cost-sharing option, user 102 may be provided with information of a pick-up area 120 where a pick-up location is bounded. For example, the pick-up area 120 may be centered around the origin location 126. In some embodiments, user 102 may be allowed to select another location different from origin location 126. For example, user 102 may be provided with options to select a place that is convenient, safe, or custom to receive the transportation service. In some embodiments, one or more locations may be recommended to user 102 based on the user's current location 122, historical service information, local regulations and custom, or other suitable factors.

In some embodiments, pick-up area 120 may be determined automatically based on factors such as the geographical area associated with origin location 126 (a city, district, region, country, etc.), time of day, traffic conditions associated with origin location 126 (e.g., traffic condition within a predetermined area covering origin location 126), or certain predetermined parameters. Pick-up area may have various shapes and coverage. For example, pick-up area 120 may be a circular area centered at origin location 126, with a predetermined or dynamically determined radius. In another example, pick-up area 120 may be of other shapes, including irregular shapes, such as defined by the number of blocks from origin location 126, a driving/walking time to origin location 126 under current, historical, or predicted traffic condition, etc.

Pick-up area 120 may be displayed by terminal device 112 to allow user 102 to assess if the pick-up location, which is bounded within pick-up area 120, is acceptable before submitting a cost-sharing service request to search for drivers and co-riders. If user 102, based on the displayed pick-up area 120, decides not to proceed with the cost-sharing option, user 102 may select other riding options without submitting the cost-sharing service request. Pick-up area 120 thus serves as a preview of the actual pick-up location to improve the degree of certainty as to where the pick-up location will be. The improved certainty can significantly reduce the cancellation rate due to users' unwillingness to take a long walk.

After user 102 is provided with information of pick-up area 120, user 102 may determine whether to submit the cost-sharing service request. For example, user 102 may click a confirmation button to submit the request. Upon receiving the request, server 172 may search for a second user associated with the cost-sharing option. For example, the second user may be a co-rider (e.g., user 106) who may share service vehicle 110 with user 102. In another example, the second user may be a service provider (e.g., user 104) for providing the requested cost-sharing transportation service. For example, server 172 may broadcast the transportation service request to potential co-riders and/or service providers close to the current location of user 102 or the origin location 126. For example, a service provider 104 may accept the request to provide the transportation service using a service vehicle 110. Server 172 may also match the request to service provider 104 and assign the transportation service to service provider 104. In another example, a co-rider may join user 102 to share service vehicle 110. In some embodiments, service provider 104 and/ may use a terminal device 114 to communicate with server 170 and/or user 102. For example, terminal device 114 may communicate with server 170 via a communication link 164, similar to communication link 162.

Terminal device 114 may provide information of service vehicle 110 and/or service provider 104 to server 172, such as the current location of service vehicle 110, whether service vehicle 110 is currently providing transportation service to other user(s), and if so, the destination or route of the current service ride. Server 172 may determine a pick-up location 124 based on the information of service vehicle 110, service provider 104, user 102, location 122, pick-up area 120, etc. For example, server 172 may determine pick-up location 124 to balance the driving distance for service provider 104 and the walking distance for user 102. In some embodiments, server 172 may recommend several candidate pick-up locations within pick-up area 120 for user 102 to choose from. User 102 may select a pick-up location from the candidates and send the selection to server 172. After pick-up location 124 is set, server 172 may provide information of the pick-up location to user 102 and service provider 104. For example, pick-up location 124 may be in a form of geographical coordinate on a map, and server 172 may determine the corresponding address, landmark, or point of interest (POI) based on the geographical coordinate, and provide the user-friendly address, landmark, or POI name to user 102 and service provider 104. Navigation routes, such as a walking route 142 from user 102's currently location 122 to pick-up location 124 and a driving route 144 from the current location of service vehicle to pick-up location 124 may be provided to user 102 and service provider 104, respectively.

Subsequent to or in parallel with searching for a driver, server 172 may search for co-riders to share service vehicle 110 with user 102. For example, server 172 may search for co-riders that are located near the current location of user 102 and instruct the co-rider(s) to meet service provider 104 at pick-up location 124 or another pick-up location. For example, user 106 may be such a co-rider. User 106 may use a terminal device 116 to request a transportation service to destination 136. Similar to the case of user 102, the request may be sent to server 172 via a communication link 166. Server 172 may match user 106 to user 102 based on their destinations (132 and 136), routes to the destinations, gender, available payment method(s), or other suitable factors. After user 106 accepts the cost-sharing arrangement, a navigation route 146 may be provided to user 106 to meet service provider 104 and co-rider 102. In some embodiment, information of user 106 may be provided to user 102 to indicate that an available co-rider is found.

In another example, server 172 may search for co-rider(s) that are on the way to one or more destinations of current rider(s) who occupy service vehicle 110. For example, user 108 may be such a candidate co-rider who is not located close to the departure location of user 102, but is near a navigation route 152 leading to user 102's destination 132. User 108 may use a terminal device 118 to communicate with server 172 via a communication link 168, similar to the case of user 102. System may match user 108 to user 102 as a co-rider and may instruct service provider 104 to take a detour 154 to pick up user 108 on the way to user 102's destination 132.

It is contemplated that searching for co-rider(s) may be conducted before, after, or together with the searching for service provider 104. In some embodiments, searching for co-rider(s) may be continuous throughout the service trip, as long as there is at least one available seat on service vehicle 110. In some embodiments, searching for co-rider(s) may be resumed after at least one seat becomes available as a result of leaving of a co-rider (e.g., arriving at the co-rider's destination). In some embodiments, there may be a maximum number of permitted stops service vehicle 110 can take during the entire service trip. For example, there may be a maximum of three stops experienced by user 102 along the way for pick-up and drop-off purposes. In some embodiments, after user 102 is within a predetermined distance to destination 132, no additional pick-up of co-rider(s) may be permitted. In some embodiment, the ratio between the distant to destination 132 and the total distance of the ride may be used as an indicator whether picking-up a new co-rider is permitted. If the ratio is below a predetermined value (e.g., user 102 is close to arrive destination 132), then no additional pick-ups may be allowed.

In some embodiments, server 172 may provide user 102 other co-riders' destinations when such destinations are on the way to user 102's destination 132. For example, a co-rider's destination may be at location 136 that is along the way to user 102's destination 132. Destination 136 may be depicted on a navigation map shown on a display of terminal device 112. In some cases, as shown in FIG. 1, destination 136 may be slightly off route 152 and service vehicle 110 may take a detour 156 to drop off a co-rider at destination 136. In some cases, a co-rider's destination 138 may be beyond user 102's destination 132. In this case, destination 138 may not be provided to user 102. Service vehicle 110 may continue along a route 158 to drop off a co-rider after completing the service trip along route 152.

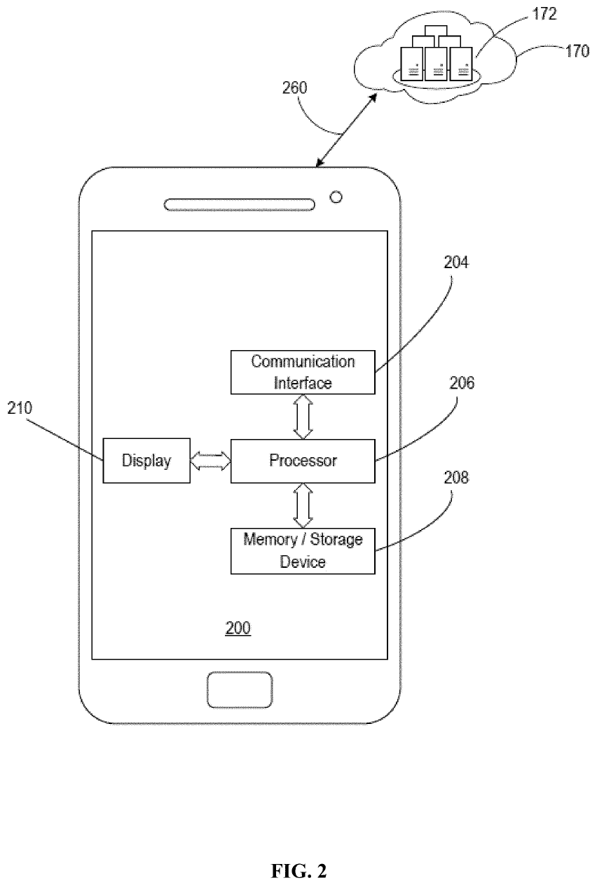

FIG. 2 is a block diagram depicting an exemplary terminal device 200, according to embodiments of the disclosure. Terminal device 200 may include any suitable device that can display information to a user, e.g., a smart phone, a tablet, a wearable device, a computer, or the like. In some embodiments, terminal device 200 may be a driver terminal (e.g., terminal device 114) used by the transportation service provider 104. In some other embodiments, terminal device 200 may be a passenger terminal (e.g., terminal device 112, 116, or 118) used by the passenger requesting the transportation service. Description of terminal device 200 will be made using a passenger terminal as an example.

As shown in FIG. 2, terminal device 200 may include a communication interface 204, a processor 206, a memory/storage device 208, and a display 210. Communication interface 204 may include an integrated services digital network (ISDN) card, cable modem, satellite modem, or a modem to provide a data communication connection. As another example, communication interface 204 may include a local area network (LAN) card to provide a data communication connection to a compatible LAN. Wireless links can also be implemented by communication interface 204. In such an implementation, communication interface 204 can send and receive electrical, electromagnetic or optical signals that carry digital data streams representing various types of information via a network. The network can typically include a cellular communication network, a Wireless Local Area Network (WLAN), a Wide Area Network (WAN), or the like.

Communication interface 204 may be configured to send a transportation service request. Transportation service request may include, among other things, passenger information, a trip origin, a trip destination, or the like. The transportation service request may be accepted by or otherwise matched with a service vehicle (e.g., service vehicle 110). Communication interface 204 may be configured to receive driver and vehicle information from server 172 or directly from a driver terminal (e.g., terminal device 114) associated with a service vehicle (e.g., service vehicle 110). Service vehicles may include taxi cars or private cars enrolled with an online hailing platform. In some embodiments, service vehicles may also include autonomous driving vehicles. The online hailing platform may maintain a database for storing profiles for the enrolled vehicles and the associated drivers. Vehicle information may include, e.g., vehicle position, vehicle year, maker, and model, as well as other features or characteristics associated with the service vehicle. Driver information may include, e.g., driver's name, picture, or other identification information, driver's license number, driving record, driver's customer reviews.

Communication interface 204 may further receive information related to the current transportation service request that the service vehicle has not yet completed. For example, communication interface 104 may receive the drop-off location of the current transportation service request. Communication interface 104 may also receive navigation information, e.g., current position of the service vehicle, traffic data, map data, after the transportation service request is accepted. In some embodiments, a navigation device onboard the service vehicle or the driver terminal may provide the vehicle position to communication interface 204. In some embodiments, communication interface 204 may be configured to receive other data from server 172, such as map data, real-time traffic information, weather information, road blocking information, etc. The updates may be received periodically, e.g., every 0.1 second, every second, every 5 seconds, or upon an update request.

Communication interface 204 may be configured to receive cost-sharing service information from server 172. For example, communication interface 204 may receive pricing information, pick-up location information, co-rider information, co-rider's destination information, etc., from server 172.

Processor 206 may include any appropriate type of general-purpose or special-purpose microprocessor, digital signal processor, or microcontroller. Processor 206 may be configured as a separate processor module dedicated to providing transportation service, including coordinating driver and rider(s), rendering map and providing navigation information. Alternatively, processor 206 may be configured as a shared processor module for performing other functions unrelated to transportation service. Processor 206 may include one or more hardware units (e.g., portion(s) of an integrated circuit) designed for use with other components or to execute part of a program. The program may be stored on a computer-readable medium, and when executed by processor 206, it may perform one or more functions related to transportation service provision.

Memory/storage device 208 may include any appropriate type of mass storage provided to store any type of information that processor 206 may process. Memory/storage device 208 may be a volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory/storage device 208 may be configured to store one or more computer programs that may be executed by processor 206 to provide transportation service, including coordinating driver and rider(s), rending map, and providing navigation information. For example, memory/storage device 208 may be configured to store program(s) that may be executed by processor 206 to providing cost-sharing transportation services.

Memory/storage device 208 may be further configured to store information and data used by processor 206. For instance, memory/storage device 208 may be configured to store the various types of data (e.g., transportation service request, vehicle information, driver information, updated trip information, map data, traffic data, cost-sharing information, etc.) received by communication interface 204. Memory/storage device 208 may also store intermediate data such as rendered map portions, navigation routes, size and shape of the elements displayed in the display region, etc. The various types of data may be stored permanently, removed periodically, or disregarded immediately after each frame of data is processed.

Display 110 may include a display such as a Liquid Crystal Display (LCD), a Light Emitting Diode Display (LED), a plasma display, or any other type of display, and provide a Graphical User Interface (GUI) presented on the display for user input and data depiction. The display may include a number of different types of materials, such as plastic or glass, and may be touch-sensitive to receive inputs from the user. For example, the display may include a touch-sensitive material that is substantially rigid, such as Gorilla Glass™, or substantially pliable, such as Willow Glass™.

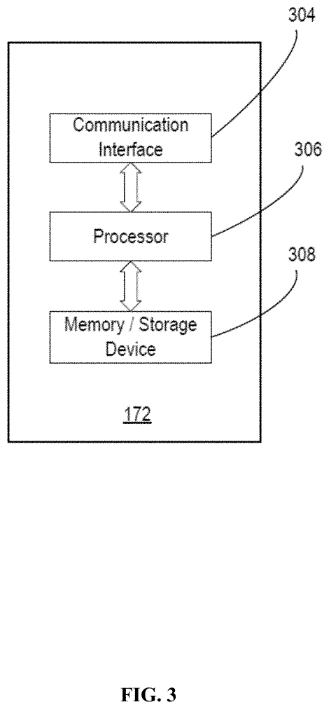

FIG. 3 is a block diagram of an exemplary server 172, consistent with some embodiments. Server 172 may include a communication interface 304, which may be similar to communication interface 204, with design features focused on server usage, such as high through-put, high availability, and high reliability. In some embodiments, communication interface 304 may receive transportation service requests from terminal devices 112, 116, and/or 118, and send service matching information to terminal 114 and/or cost-sharing matching information to terminal device 116 and/or 118. In some embodiments, communication interface 304 may send pick-up location information and/or navigation route information to terminal devices 112, 114, 116, and/or 118.

Server 172 may also include at least one processor 306. Processor 306 may be any suitable type of processors, and may be similar to processor 206 but with design features focused on server usage, such as high speed, multi-core, low latency, high reliability, high availability, and the ability to conduct parallel computing. Processor 306 may process the service requests received by communication interface 304 and determine the matching service vehicle(s) to fulfil the requests. Processor 306 may also determine co-riders to share the same service vehicle to save on cost. In some embodiments, processor 306 may determine the proper price for the cost-sharing option depending on factors such as demand-supply, historical pricing information, time of day, probability of success, etc.

Server 172 may further include a memory/storage device 308, which may include any types of mass storage devices. Memory/storage device 308 may be similar to memory/storage device 208, but with design features focused on server usage, such as high capacity, high through-out, high reliability, high availability, high speed, etc.

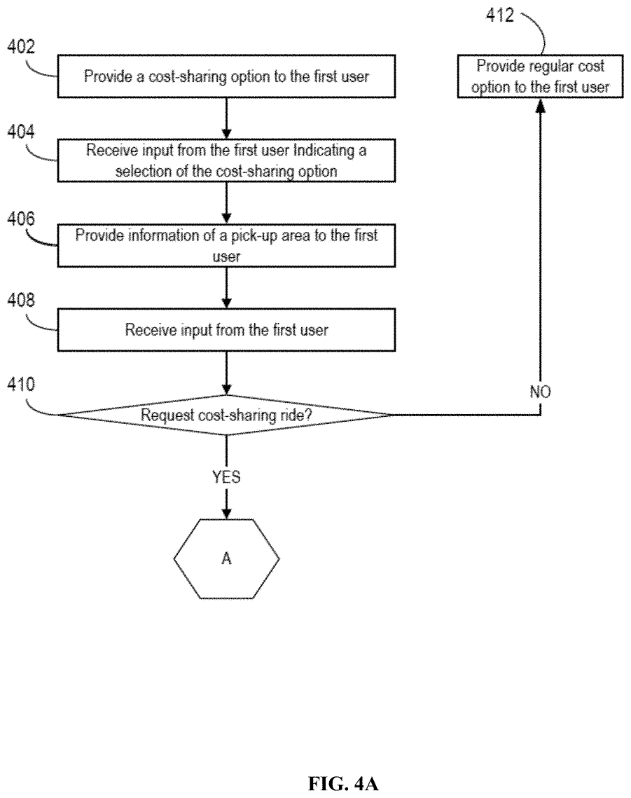

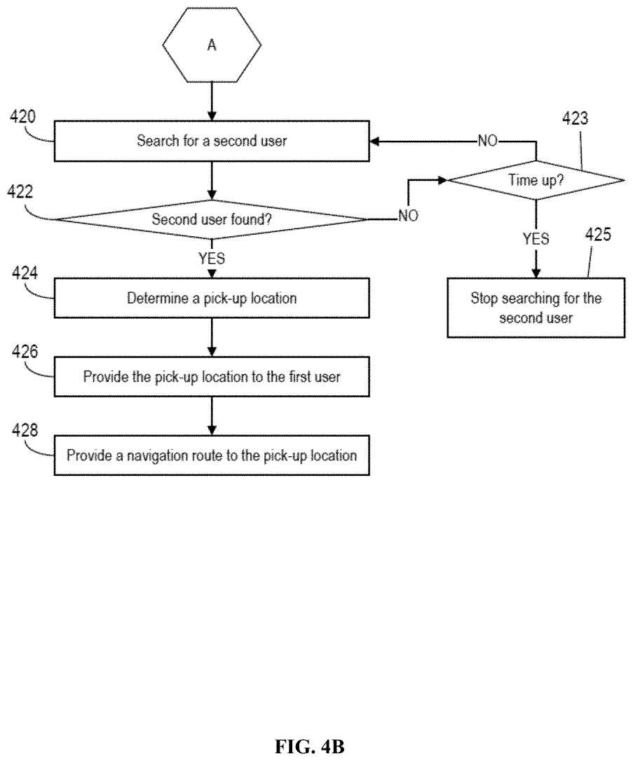

FIGS. 4A-4B illustrate a flowchart of an exemplary method 400 for providing a cost-sharing transportation service. Method 400 may be implemented by terminal device 112/116/118, by server 172, or jointly by the terminal device and server. It is contemplated that any step of method 400 can be performed by processor 206 alone, by processor 306 alone, or jointly by processors 206 and 306. In the following, processor 206 is used as an example in describing the steps of method 400. Method 400 may include multiple steps, as described below. It is to be appreciated that some of the steps may be optional to perform the embodiments provided herein. Further, some of the steps may be performed simultaneously, or in a different order than shown in FIGS. 4A-4B.

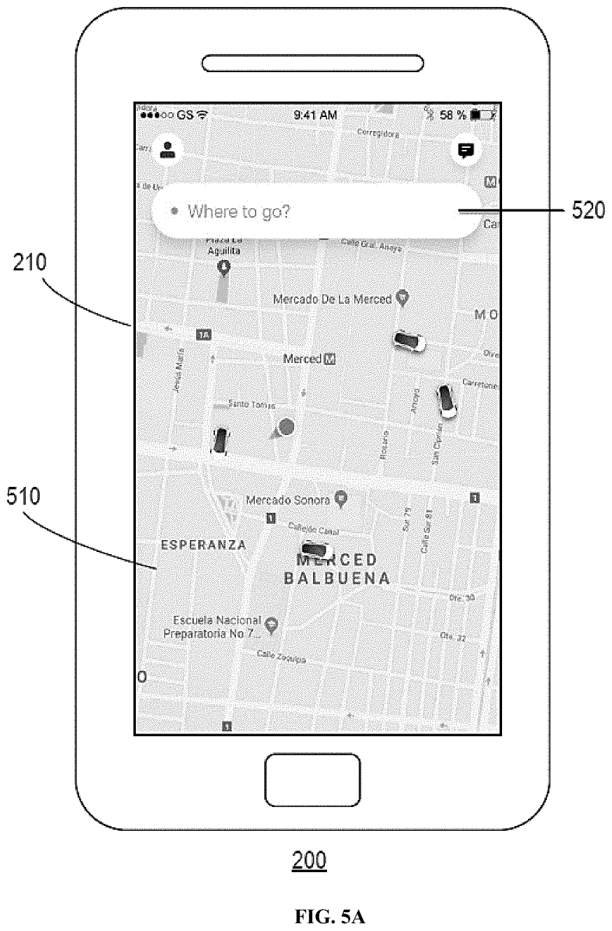

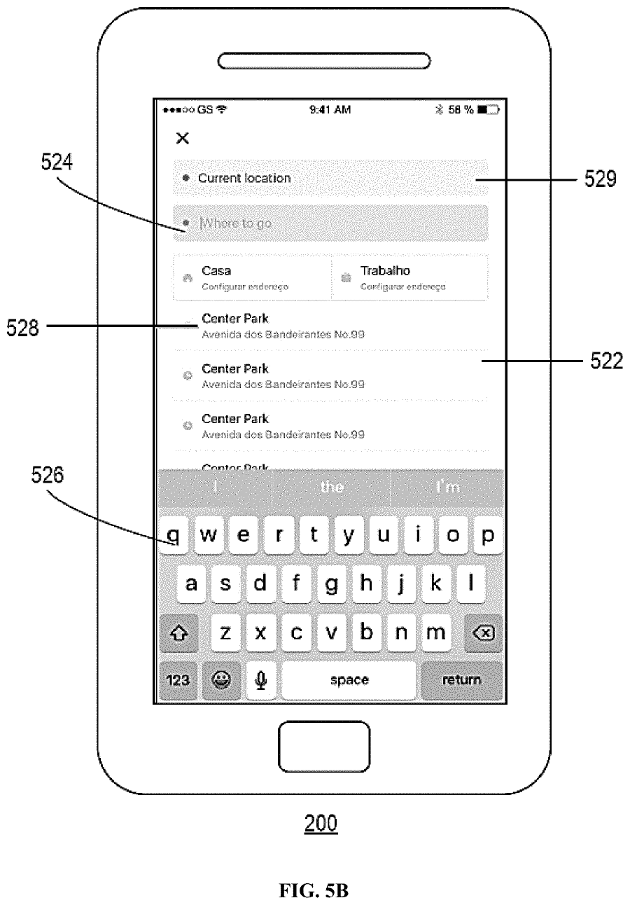

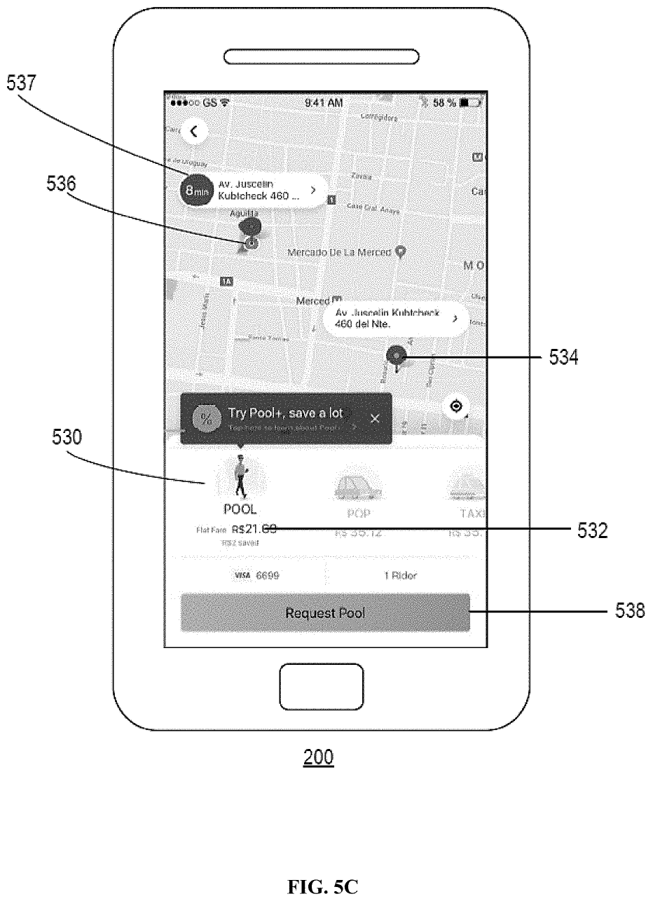

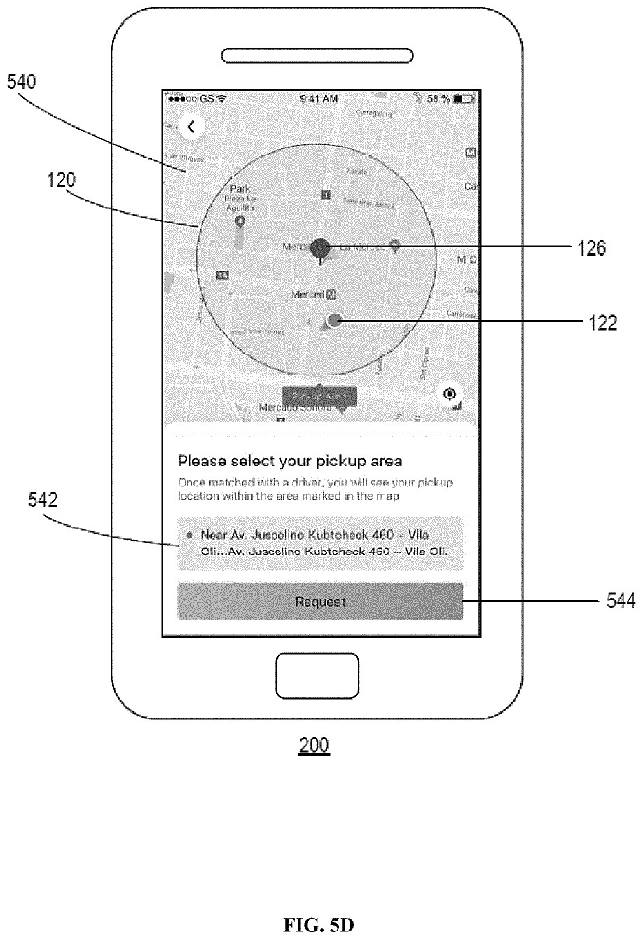

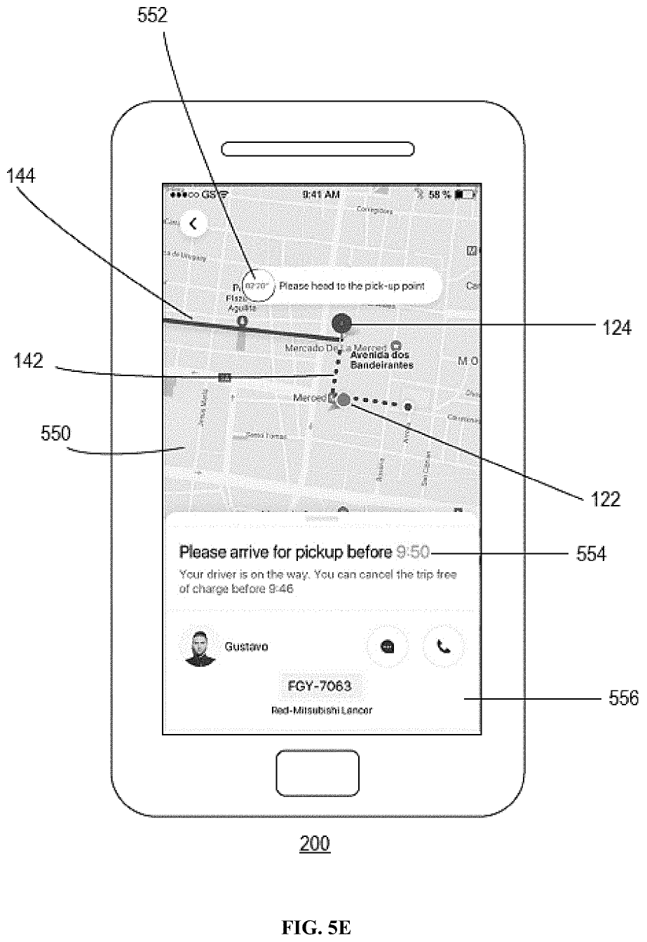

In step 402, processor 206 may provide a cost-sharing option to a first user (e.g., user 102). In some embodiments, the cost-sharing option may be provided as an option before receiving user input about the origin/destination location information. For example, user 102 may be provided with one or more transportation service options including the cost-sharing option after user 102 start a transportation service application installed on terminal device 112. In some embodiments, the cost-sharing option may be provided as the default transportation service option. In some embodiments, the cost-sharing option may be provided based on a determination of whether the origin and/or destination location is within a cost-sharing service zone. For example, processor 206 may receive a request from user 102 for a transportation service to a first destination (e.g., destination 132). FIG. 5A shows an exemplary user interface 510 displayed on display 210 of terminal device 200, in which user 102 may input destination information into an input bar 520. After user 102 clicks on input bar 520, a destination information user interface 522 may be display, as shown in FIG. 5B, in which user 102 may enter an address or description of the destination in the destination bar 524 using a soft keyboard 526, or by clicking on one of the suggested destinations from a list 528. In addition, user 102 may use his/her current location as the origin of the transportation service or input a different origin in an origin information bar 529.

In some embodiments, processor 206 may determine whether the destination and/or origin falls within a predetermined geographical area, such as a carpool zone where the cost-saving transportation service is provided. In some embodiments, processor 206 may determine whether both the origin and destination fall within the carpool zone. In some embodiments, processor 206 may determine whether one of the origin or destination falls within the carpool zone. If it is determined that the requested ride does not fall within a carpool zone, user 102 may be provided with a regular cost option. On the other hand, if it is determined that the requested ride falls within the carpool zone, user 102 may be provided with a cost-sharing option.

An exemplary interface providing the cost-sharing option to user 102 is shown in FIG. 5C. As shown in FIG. 5C, the cost-sharing option is provided as a carpool option 530. The carpool option may be accompanied with a price 532, which may be discounted over the regular price as a reward to user 102's willingness to share a service vehicle with other co-rider(s). The price may be determined based on a variety of factors, such as a geographical area associated with the transportation service (e.g., different cities may have different prices for similar rides), a demand of transportation services within the geographical area (e.g., a higher demand may be associated with a higher price), a supply of transportation services within the geographical area (e.g., a lower supply may be associated with a higher price), a history of past transportation services having the cost-sharing option (e.g., historical carpooling prices may be used as guidelines or benchmarks), a probability of locating at least a co-rider for sharing the cost of the transportation service (e.g., if the probability of locating a co-rider is relatively low, then the price may be relatively high), a time of day (e.g., rush hours may be associated with higher price), etc. In some embodiments, the price may be a fixed price (e.g., a flat rate 538 as shown in FIG. 5C), which is not changed regardless of whether a co-rider is located to actually share the service vehicle. In some embodiments, the price may be dynamically adjusted depending on the number of co-riders who actually shared the service vehicle. User 102 may also be provided with a waiting time 537 indicating an estimation of time required to locate a co-rider and/or a driver.

In step 404, processor 206 may receive input from user 102 indicating a selection of the cost-sharing option. For example, as shown in FIG. 5C, user 102 may click button 538 to request the transportation service with cost-sharing option. Otherwise, use 102 may select other options such as regular ride, taxi, etc.

In step 406, user 102 may be provided with information of a pick-up area 120. FIG. 5D shows an exemplary interface 540 depicting an exemplary pick-up area 120. In some embodiments, pick-up area 120 may be centered around origin location 126. As described above, the shape of pick-up area 120 may vary. Therefore, although FIG. 5D shows a circular pick-up area, other shapes may also be used. In addition, the boundary of pick-up area 120 relative to location 126 may be predetermined (e.g., 50 meters, 100 meters, 200 meters, 5 mins of walking distance, 4 blocks, etc.) or dynamically determined (e.g., smaller when it is raining and larger when it is sunny, smaller when traffic is heavy and larger when traffic is light, etc.). In some embodiments, the boundary of pick-up area 120 may be determined based on a geographical location associated with origin location 126. For example, in a city where potential co-rider and/or drivers are abundant, pick-up area 120 may be relatively small. On the other hand, in a rural area where potential co-rider and/or drivers are sparse, pick-up area may be relatively large. In some embodiments, information of pick up area 120 may be provided to user 102 in an information block 542, indicating the pick-up location would be near an address or a point of interest. As shown in FIG. 5D, origin location 126 may or may not be the same as user 102's current location 122.

In step 408, processor 206 may receive input from user 102 indicating whether user 102 decides to proceed with requesting the cost-sharing service. For example, user 102 may click the “Request” button 544 shown in FIG. 5D through interface 540 to request the cost-sharing transportation service.

In step 410, processor 206 may determine whether user 102 requests the cost-sharing service ride (e.g., by clicking a confirmation button via interface 540). If not (e.g., user 102 clicks a “Back” key via interface 540), then method 400 proceeds to step 412, in which processor 206 may provide regular cost option(s) to user 102. On the other hand, if user 102 does request the cost-sharing service option (e.g., by clicking the “Request” button 544 shown in FIG. 5D), then method 400 proceeds to an intermediate step A. FIG. 4B shows exemplary processes following step A.

Turning to FIG. 4B, method 400 proceeds from step A to step 420, in which processor 206 may search for a second user associated with the request cost-sharing transportation service. As discussed above, the second user may be a co-rider or a service provider. For example, user 102's transportation request may be broadcast to potential co-riders and/or service providers within an area close to user 102 to wait for at least one second user to accept the request. In another example, a second user may be selected to match the request. In step 422, processor 206 may determine if the second user is found. If not, then method 400 proceeds to step 423, in which processor 206 may determine if a predetermined time duration (e.g., the maximum waiting period) has passed. If not, method 400 returns to step 420 to make further attempts to locate a second user. If, however, the predetermined time duration has lapsed in step 423, method 400 proceeds to step 425, in which processor 206 may stop searching for the second user. For example, when the second user is a co-rider, processor 206 may stop searching for a co-rider to share the service vehicle with user 102. When the second user is a driver, processor 206 may inform user 102 that the requested transportation service with the cost-sharing option is not available, and may suggest other ride options.

Returning to step 422, if an available second user is found in step 422, the method 400 proceeds to step 424, in which processor 206 may determine a pick-up location (e.g., pick-up location 124). As discussed above, pick-up location 124 may be within the pick-up area 120.

In some embodiments, pick-up location 124 may be determined based on historical data. For example, pick-up location information of past transportation requests may be collected and analyzed to determine optimal pick-up locations within pick-up area 120. Various factors may be used to determine the pick-up location 124. For example, the frequency of a particular place is used as a pick-up location may indicate the place is suitable for serving as a convenient pick-up place. Similarly, the number of orders, the distribution of pick-ups throughout the day, etc., can also be used as the factors.

In some embodiments, pick-up location 124 may be determined by optimizing a pick-up route 144 between a service vehicle's location to the pick-up location. For example, pick-up location 124 may be selected at places that minimizes the distance, driving time, or traffic for driver 104 to reach pick-up location 124 from its current location. In another example, the pick-up location 124 may be selected at one side of a road so that drive 104 does not have to make a U-turn other complicated or time-consuming routes. In a further example, the pick-up location 124 may be selected at places permitting passenger pick-up, such as the entrance of a hotel, park, etc., and by avoiding places such as bus stops, traffic circles, etc.

In some embodiments, pick-up location 124 may be determined to minimize a likelihood of cancellation of the transportation service. For example, a learning model may be trained based on historical data correlating pick-up locations and cancellations of service. The learning model may then be used to predict, based on factors of a current service request and available pick-up locations, a probability of cancellation for each available pick-up location. Processor 206 may select the pick-up location that is associated with the lowest probability of cancellation.

In some embodiments, processor 206 may first determine the pick-up location in the form of geographical coordinates based on factors discussed above. After the geographical coordinates of the pick-up location is determined, the address or point of interest corresponding to the geographical coordinates may be determined based on, for example, map data.

In some embodiments, processor 206 may determine one or more candidate pick-up locations. In some embodiments, the candidate pick-up locations may be within pick-up area 120. Processor 206 may provide the candidate pick-up locations to user 102 and may receive input from user 102 indicating a selection of a pick-up location from the candidate pick-up locations.

In some embodiments, processor 206 may determine the one or more candidate pick-up locations based on historical information of pick-up locations from past transportation services. In some embodiments, processor 206 may access history pick-up location data which may include relationship between past pick-up locations and user locations. For example, history pic-up location data may include information of actual pick-up locations corresponding to origin locations and a current location of a user. Candidate pick-up location(s) may be selected from those actual pick-up locations (e.g., the most popular pick-up location(s)).

In some embodiment, processor 206 may determine one or more candidate pick-up locations based on a location of a service vehicle providing the cost-sharing transportation service. For example, candidate pick-up locations may be selected from those having the shortest average distance for the service vehicle or having the shortest pick-up time for the service vehicle.

In step 426, the pick-up location may be provided to user 102. FIG. 5E shows an exemplary interface 550 depicting the pick-up location 124, walking route 142, and driving route 144. As shown in FIG. 5E, a count down timer 552 may be provided to user 102 indicating the time left for user 102 to walk to the pick-up location 124. In addition, a suggested arrival time 554 may also be provided in the information tab 556.

Returning to FIG. 4B, method 400 may proceed from step 426 to step 428, in which processor 206 may provide a navigation route to the pick-up location to user 102. As shown in FIG. 5E, the navigation route 142 leading to the pick-up location 124 is shown in interface 550.

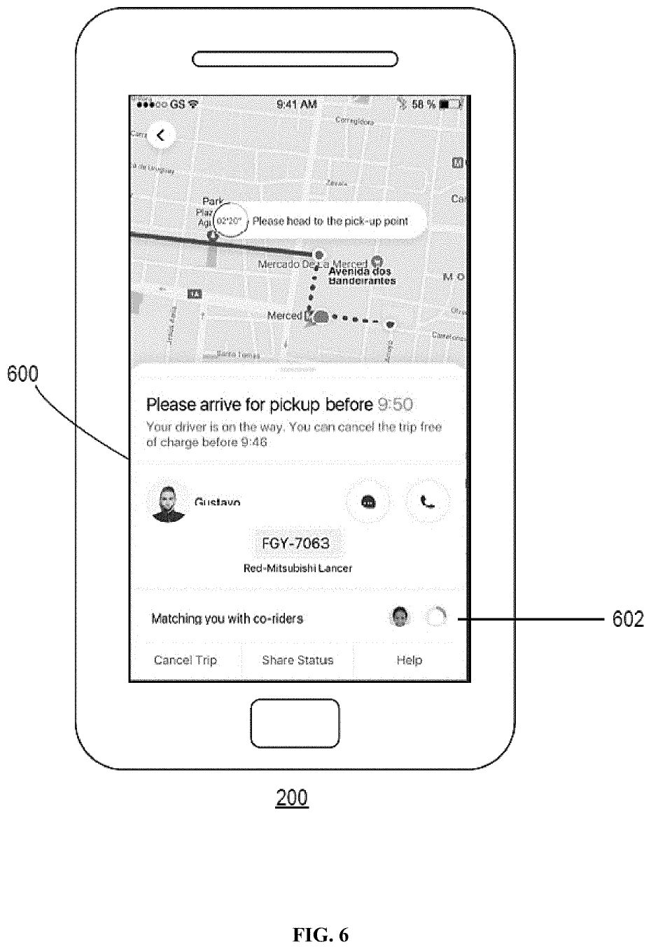

In some embodiments, processor 206 may search for a co-rider for sharing the cost of the transportation service in step 420 and provide to user 102 an indication of the availability of the co-rider. For example, FIG. 6 shows an exemplary interface 600 that includes a co-rider matching section 602. Section 602 may include one or more available co-rider and an indication to search for additional co-rider(s). In some embodiments, processor 206 may determine an available co-rider based on the destination of the co-rider and the destination of user 102. For example, processor 206 may receive a transportation service request from a third user to a second destination, similar to receive a transportation service request from user 102. Processor 206 may determine whether the second destination is close to the first destination, for example, by calculating a distance between the two destinations. If the distance between the two destinations are within a predetermined threshold, then processor 206 may determine the third user is available as a co-rider to share the service vehicle with user 102.

In another example, processor 206 may determine the driving time between the first and second destination. If the driving time is less than a predetermined threshold, then processor 206 may determine that the third user is available as a co-rider.

In a further example, processor 206 may determine a first driving route for user 102 and a second driving route for the third user. If the two driving routes are overlapping, for example to a degree higher than a threshold (e.g., 70% overlapping, 80% overlapping, etc.), then processor 206 may determine that the third user is available as a co-rider. In this case, the second destination does not need to be close to the first destination. As long as the first and second routes are sufficiently overlapping, the third user may be determined as a co-rider.

After it is determined that a co-rider is available, the co-rider may be provided with an invitation to join user 102 to share the service vehicle 110. After the co-rider accepts the invitation, information of the co-rider may be provided as an update to user 102. For example, as shown in FIG. 6, a profile photo of the co-rider may appear in the co-rider matching section 602.

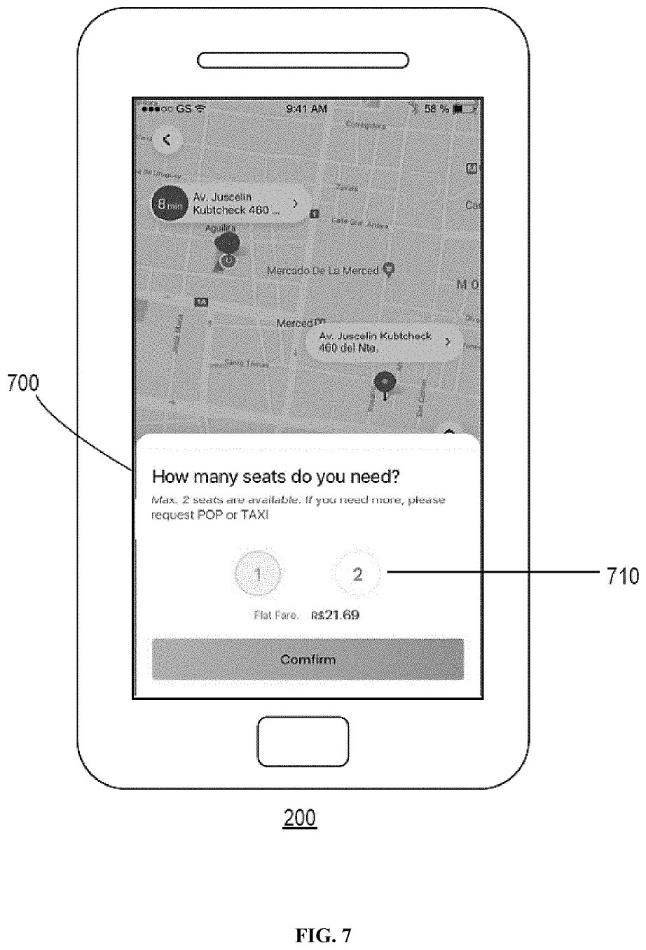

In some embodiments, user 102 may be requested to confirm the number of seats needed for the ride. For example, FIG. 7 shows an exemplary interface 700 depicting a seat selection tab 710. In some embodiment, one seat may be set as the default number of seats for the cost-sharing option. User 102 may select the desired number of seats, up to an upper limit (e.g., two seats maximum).

In some embodiments, additional co-riders may be permitted to share the service vehicle as long as there are available seats on the service vehicle. In some embodiments, to avoid frequent stops, a maximum number of stops may be set for a cost-sharing ride. For example, a maximum 3 stops may be set to improve ride's experience. When the maximum number of stops is reached, additional cost-sharing requests may be declined.

In some embodiment, when the service vehicle is close to the destination of user 102 or any co-rider, additional cost-sharing requests may also be declined. For example, processor 206 may determine the distance between the current location of the service vehicle and destination 132. If the distance is shorter than a threshold, then additional cost-sharing requests may be declined. In another example, when a ratio between the distance to the destination and a total distance measured from the pick-up location to the destination is below a predetermined value, indicating the user is close to the destination, additional co-rider requests may be declined.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A system for providing a cost-sharing transportation service, comprising:
a memory storing computer-readable instructions; and
at least one processor coupled to the memory, wherein the instructions, when executed by the at least one processor, cause the processor to perform operations comprising:
providing a cost-sharing option to a first user;
receiving input from the first user indicating a selection of the cost-sharing option;
providing information of a pick-up area to the first user based on an origin location associated with the first user;
searching for a second user associated with the cost-sharing option based on the origin location;
determining, based on information associated with the second user the pick-up area, a pick-up location associated with the cost-sharing option; and
providing, to the first user, information of the pick-up location.

2. The system of claim 1, wherein the operations comprise:
determining the pick-up area based on at least one of a predetermined distance from the origin location, a geographical area associated with the origin location, traffic conditions associated with the origin location, or a time of day.

3. The system of claim 1, wherein:
the second user is a co-rider with the first user; and
the operations comprise:
providing the information of the pick-up location to the first user after the second user is found.

4. The system of claim 3, wherein the operations comprise:
receiving input from the first user indicating a first destination location associated with the cost-sharing option; and
searching for the second user based on the first destination location.

5. The system of claim 4, wherein the operations comprise:
determining that the second user is found when a distance between a second destination location associated with the second user and the first destination location is below a predetermined threshold.

6. The system of claim 4, wherein the operations comprise:
determining that the second user is found when a driving time from a second destination location associated with the second user to the first destination location or from the first destination location to the second destination location is below a predetermined threshold.

7. The system of claim 4, wherein the operations comprise:
determining a first route from a first location within the pick-up area to the first destination location;
determining a second route from the first location to a second destination location associated with the second user; and
determining that the second user is found when a degree of overlapping between the second route and the first route is greater than a predetermined threshold.

8. The system of claim 1, wherein the operations comprise:
adding one or more users to the cost-sharing option when at least one seat is available for providing the cost-sharing transportation service.

9. The system of claim 1, wherein the operations comprise:
adding one or more users to the cost-sharing option when a count of stops along a route of the cost-sharing transportation service is below a predetermined threshold.

10. The system of claim 1, wherein the operations comprise:
declining a request for joining the cost-sharing option when a distance between a current location of the first user and a destination location associated with the first user is less than a predetermined threshold or when a ratio between the distance and a total distance from the pick-up location to the destination location is below a predetermined value.

11. The system of claim 1, wherein the operations comprise:
determining the pick-up location based on the origin location and a location of the second user by optimizing a distance between the origin location and the pick-up location and a distance between the location of the second user and the pick-up location.

12. The system of claim 1, wherein the operations comprise:
determining one or more candidate pick-up locations within the pick-up area; and
providing, to the first user, the one or more candidate pick-up locations.

13. The system of claim 12, wherein the operations comprise: determining the one or more candidate pick-up locations based on at least one of
historical information of pick-up locations from past transportation services, or
a location of a service vehicle providing the cost-sharing transportation service.

14. (canceled)

15. The system of claim 1, wherein the operations comprise:
providing, to the first user, at least one of an indication of a destination location of the second user or a navigation route to the pick-up location.

16. The system of claim 1, wherein:
the second user is a service provider for providing the cost-sharing transportation service; and
the operations comprise:
providing the information of the pick-up location to the first user after the second user is found.

17. The system of claim 1, wherein the operations comprise:
determining an address or point of interest corresponding to the pick-up location; and
providing the address or point of interest to the first user.

18. The system of claim 1, wherein the operations comprise determining a price associated with the cost-sharing option based on at least one of:
a geographical area associated with the transportation service;
a demand of transportation services within the geographical area;
a supply of transportation services within the geographical area;
a history of past transportation services having the cost-sharing option;
a probability of locating at least the second user for sharing the cost of the transportation service; or
a time of day.

19. The system of claim 18, wherein the operations comprise:
determining the price to be a fixed price; and
providing the fixed price to the first user as part of the cost-sharing option.

20. (canceled)

21. A method for providing a cost-sharing transportation service implemented on a machine including one or more storage devices and one or more processors, comprising:
providing a cost-sharing option to a first user;
receiving input from the first user indicating a selection of the cost-sharing option;
providing information of a pick-up area to the first user based on an origin location associated with the first user;
searching for a second user associated with the cost-sharing option based on the origin location;
determining, based on information associated with the second user the pick-up area, a pick-up location associated with the cost-sharing option; and
providing, to the first user, information of the pick-up location.

22-40. (canceled)

41. A non-transitory computer-readable medium that stores a set of instructions, when executed by at least one processor of an electronic device, cause the electronic device to perform a method for providing a cost-sharing transportation service, the method comprising:
providing a cost-sharing option to a first user;
receiving input from the first user indicating a selection of the cost-sharing option;
providing information of a pick-up area to the first user based on an origin location associated with the first user;
searching for a second user associated with the cost-sharing option based on the origin location;
determining, based on information associated with the second user the pick-up area, a pick-up location associated with the cost-sharing option; and
providing, to the first user, information of the pick-up location.
